(19) United States
(12) Patent Application Publication
(10) Pub. No.: US 2018/0089839 A1
(43) Pub. Date: Mar. 29, 2018

(54) MOVING OBJECT DETECTION BASED ON MOTION BLUR

(71) Applicant: Nokia Technologies Oy, Espoo (FI)

(72) Inventor: Xiaoli Li, Tianjin (CN)

(21) Appl. No.: 15/558,411

(22) PCT Filed: Mar. 16, 2015
(86) PCT No.: PCT/CN2015/074281

§ 371 Date: Sep. 14, 2017

(51) Int. Cl. G06T 7/246; G06T 7/269; G06K 9/62; G06K 9/20; G06K 9/00

(52) U.S. Cl. CPC G06T 7/248; G06T 7/269; G06K 9/6201; G06K 9/6267; G06K 2209/21; G06K 9/2054; G06K 9/00718; G06T 2207/10016; G06K 9/623

(57) ABSTRACT

The present disclosure relates to moving object detection based on motion blur. In one embodiment, variances of a pixel in an image for a set of frequencies are determined based on a gradient of the pixel. A degree of matching between the pixel and a set of blur kernels for the set of frequencies is then obtained based on the variances of the pixel, each of the blur kernels characterizing a type of motion that causes a blur in the image. The pixel is classified as a motion-blurred or non-motion-blurred pixel based on the degree of matching.

### FIELD

The present disclosure generally relates to video processing, and more specifically, to moving object detection in images or videos.

### BACKGROUND

Detecting moving objects such as persons, automobiles and the like in the video plays an important role in video analysis such as intelligent video surveillance, traffic monitoring, vehicle navigation, and human-machine interaction. In the process of video analysis, the outcome of moving object detection can be input into the modules for object recognition, object tracking, behavior analysis or any other further processing. The accurate moving object detection is a key for successful video analysis.

In order to detect moving objects in the videos, conventional approaches usually rely on the differences or changes between adjacent images/frames. However, the inter-frame differences are not necessarily be caused by the motion of objects. For example, dynamic background (e.g., water ripples and waving trees), illumination variation, and noise can also cause differences between the frames. As a result, some of the background might be misclassified as moving objects, and parts of foreground might be misclassified as background.

### SUMMARY

In general, embodiments of the present invention provide a solution for moving object detection based on motion blur.

In one aspect, a computer-implemented method is provided. The method comprises: determining variances of a pixel in an image for a set of frequencies based on a gradient of the pixel; calculating a degree of matching between the pixel and a set of blur kernels for the set of frequencies based on the variances of the pixel, each of the blur kernels characterizing a type of motion that causes a blur in the image; and classifying the pixel as a motion-blurred pixel or a non-motion-blurred pixel based on the degree of matching.

In another aspect, a computer-implemented method is provided. The method comprises: for each of a plurality of frames in a video, classifying each pixel in the frame as a motion-blurred pixel or a non-motion-blurred pixel according to the claim as outlined above, and generating a foreground indicator for the frame based on the classifying, the foreground indicator indicating the motion-blurred pixels; generating a foreground indicator for the video based on the foreground indicators for the plurality of frames; and detecting a moving object in the video based on the foreground indicator for the video.

In yet another aspect, an apparatus is provided. The apparatus comprises: a pixel variance determining unit configured to determine variances of a pixel in an image for a set of frequencies based on a gradient of the pixel; a matching unit configured to calculate a degree of matching between the pixel and a set of blur kernels for the set of frequencies based on the variances of the pixel, each of the blur kernels characterizing a type of motion that causes a blur in the image; and a pixel classifying unit configured to classify the pixel as a motion-blurred pixel or a non-motion-blurred pixel based on the degree of matching

In still yet another aspect, an apparatus is provided. The apparatus comprises: the apparatus as outlined above which is configured to classify each pixel in each of a plurality of frames in a video as a motion-blurred pixel or a non-motion-blurred pixel; a frame-level indicator generating unit configured to generate foreground indicators for the plurality of frames based on the classifying, each of the foreground indicators indicating the motion-blurred pixels in the respective frame; a video-level indicator generating unit configured to generate a foreground indicator for the video based on the foreground indicators for the plurality of frames; and a moving object detecting unit configured to detect a moving object in the video based on the foreground indicator for the video.

Other features and advantageous will be appreciated through the following detailed descriptions of example embodiments of the present invention.

### BRIEF DESCRIPTION OF THE DRAWINGS

FIG. 1 shows a flowchart of a method of classifying image pixels based on the motion blur according to example embodiments of the present invention;

FIG. 2 shows a flowchart of a method of detecting moving objects in a video based on the motion blur according to example embodiments of the present invention;

FIG. 3 shows a block diagram of an apparatus for classifying image pixels based on the motion blur according to example embodiments of the present invention;

FIG. 4 shows a block diagram of an apparatus for detecting moving objects in a video based on the motion blur according to example embodiments of the present invention; and

FIG. 5 shows a block diagram of an example computer system suitable for implementing example embodiments of the present invention.

Throughout the drawings, the same or corresponding reference symbols refer to the same or corresponding parts.

### DETAILED DESCRIPTION OF EXAMPLE EMBODIMENTS

Example embodiments of the present invention will now be discussed with reference to several example implementations. It should be understood these implementations are discussed only for the purpose of enabling those skilled persons in the art to better understand and thus implement embodiments of the invention, rather than suggesting any limitations on the scope of the invention.

As used herein, the term “includes” and its variants are to be read as opened terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” “third” and the like may be used to refer to different or same objects. Other definitions, explicit and implicit, may be included below.

Traditionally the Gaussian Mixture Model can be used to characterize the background of an image or video. The pixel deviating much from the model is considered as foreground. In such approaches, the correlation between neighboring pixels is not fully taken into account. Some other conventional solutions rely on linear model to describe the background. Due to the dynamic background such as water ripples and waving trees, illumination variation, camera motion, and other noises, misclassification of the pixels might occur.

The inventors have found that the image pixels belonging to a moving object will be blurred at least to some extend due to motion. As such, in accordance with embodiments of the present invention, the blur motion is used to detect the moving objects in the images or videos. More specifically, motion-blurred regions in each image may be detected. Then these motion-blurred regions may be combined to detect the moving objects accurately and robustly.

In the proposed approach, given an image, it is necessary to find the pixels in the image that are blurred by the motion of an object(s). In the context of the present invention, such pixels are referred to “motion-blurred pixels.” On the other hand, those pixels that are not blurred by the motion are referred to as “non-motion-blurred pixels.” In accordance with embodiments of the present invention, the motion-blurred pixels may be considered as belonging to a moving object(s) and thus classified as foreground pixels. The non-motion-blurred pixels, on the other hand, may be classified as background pixels. For the sake of discussion, the terms “foreground” and “moving object” can be used interchangeably.

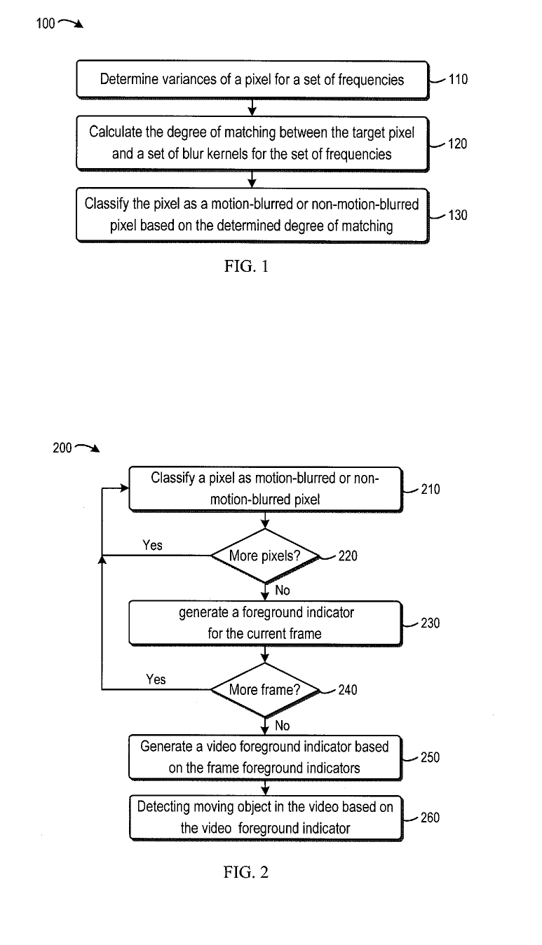

FIG. 1 shows the flowchart of a method of classifying pixels as motion-blurred or non-motion-blurred pixels in accordance with example embodiments of the present invention. The input image z can be either a single image or a frame in a video. The method 100 can be applied to one or more pixels in the image. For each pixel, output of the method 100 indicates whether this pixel is blurred by the motion of a moving object(s) in the image. For the sake of discussion, in the following the method 100 will be described with reference to a target pixel n in the image.

As shown, the method 100 is entered at step 110 where the variances of the target pixel n for a set of predefined frequencies. It is known that an image may include signals of different frequencies and the frequencies indicate the variance or distribution of the gray scales of the pixels in the image. The signals of different frequencies can be extracted by transforming the image into the frequency domain, for example. By way of example, the short-time Fourier transform and its variations or implementations may be applied to the image such that the image is transformed into the frequency domain.

In implementation, given a set of frequencies including one or more predefined frequencies, it is possible to define a set of filters each of which corresponds to one of the predefined frequencies. It is supposed that the set of frequencies include r different frequencies where r is a predefined natural number. In one embodiment, the value of r can be set as 15, for example. Of course, any other suitable value is possible as well. In one embodiment, the set of filters may be defined as:

fᵢ[n]=W[n]exp(−j [symbol] ωᵢ,n [symbol] ) (1)

where i=1, . . . , r, W represents a window function, ωᵢ, represents the sampling frequency, and <,> represents inner product operator. Specifically, in one embodiment, the filters may be orthogonal to one another. That is, the filters satisfy the following constraints:

<fᵢ,fⱼ>=0,i≠j (2)

In accordance with embodiments of the present invention, in step 110, the variance of the pixel n with respect to each of the predefined frequencies may be determined based on the gradient of the pixels. In one embodiment, it is possible to only use the gradient of the target pixel n. Alternatively, the gradients of pixels around the target pixel n may be taken into account, such that the variances are estimated more accurately. In such embodiments, the gradients of the pixels within the input image z can be calculated. These gradients together form a gradient image of the image z, denoted as X.

Within the gradient image X, a local region around the target pixel n may be extracted. The extracted local region may be of any size and shape. Only by way of example, in one embodiment, the local region may be a square. The gradients of the pixels in the local region may be represented as a vector x. In some embodiments, the variance of the target pixels n for any given predefined frequency is calculated by filtering the local region with the corresponding filter.

More specifically, in such embodiments, the extracted local region is filtered by the set of filters corresponding to the one or more predefined frequencies, as follows:

yᵢ[n]=(x [symbol] fᵢ)[n] (3)

where i=1, . . . , r. Then, in one embodiment, the variance of the target pixel n for the set of frequencies may be determined as follows:

σ_{yi}²=E|(x [symbol] fᵢ)[n]|² (4)

where E(•) represents an expectation operator, and [symbol] represents a convolution operator. It is to be understood that the variances given by equation (4) are discussed merely for the purpose of illustration, without suggesting any limitation as to the scope of the invention. Given the filtering result yᵢ[n], the variances of the target pixel for the frequencies may be obtained in any other suitable ways.

Still with reference to FIG. 1, the method 100 proceeds to step 120 where the degree of matching between the target pixel and a set of blur kernels is calculated for the set of frequencies. As used herein, the term “blur” refers to image degradation caused by the object motion. As known, the blur can be characterized by a “blur kernel.” A blur kernel characterizes a certain type of motion that causes the related pixels to be blurred. A blur kernel, for example, may describe the direction, amount and/or any other relevant respects of the motion. In one embodiment, it is possible to define one or more blur kernels, each of which is assumed to be one of a discrete set of possible candidates of the object motion in respective directions. For example, each blur kernel can be represented by a filter of a certain length.

Only by way of example, it is supposed that a set of blur kernels K={k₁, . . . , km} is defined, including the kernels charactering the horizontal and vertical object motions. Within this set, a blur kernel kᵢ may be a horizontal rectangle filter of the length l, where the length corresponds to number of pixels the object moved. Formally, the blur kernel kᵢ may be represented, for example, as follows:

$${k}_{i} [ n ] = \{ \begin{matrix}1 / l & if {n}_{x} = 0 , 0 \leq {n}_{y} < l \\ 0 & otherwise\end{matrix} \qquad ( 5 )$$

where nₓ and n_{y} represent the horizontal and vertical coordinates of the pixel n, respectively. The other blur kernels may be similarly defined for various lengths of interest. It is to be understood that the blur kernels as defined above are discussed merely for the purpose of illustration, without suggesting any limitation as to the scope of the present invention. Other definitions of the blur kernels are possible as well.

In accordance with embodiments of the present invention, the degree of matching between the target pixel and the set of blur kernel indicates the degree of impacts of the blur kernels at the target pixel. In one embodiment, in step 120, the degree of matching may be determined at least in part based on the variances of the target pixel as calculated in step 110. For example, in some embodiments, the variances of the blur kernels with respect to the set of predefined frequencies may be determined. To this end, the filters fᵢ corresponding to the frequencies may be applied to the predefined blur kernels:

σₖᵢ²=E|(k [symbol] fᵢ)[n]|² (6)

Then the degree of matching between the target pixel and the one or more blur kernels may be determined based on the variances of the target pixel σ_{yi}² and the variances of the blur kernel σₖᵢ² for the set of predefined frequencies. For example, in one embodiment, the ratio and/or difference between the variances σ_{yi}² and σₖᵢ² may be used to measure the degree of matching.

Alternatively, in some embodiments, more sophisticated metric may be used to measure the matching between the pixel and the blur kernels. For example, in one embodiment, the variance of the blur kernels σₖᵢ² may be normalized. The normalization may be done, for example, as follows:

$${w}_{i} = \frac{{σ}_{ki}^{2}}{Δ} \qquad ( 7 )$$

where Δ represents a normalization coefficient. By way of example, in one embodiment, the normalization coefficient may be determined in the following way:

$$Δ = \sqrt{{\sum }_{i = 1}^{r} {σ}_{ki}^{4}} \qquad ( 8 )$$

In step 120, the degree of matching between the target pixel and the blur kernels may be calculated as a confidence value given below:

$$P ( n ) = ( {\sum }_{t = 1}^{r} {w}_{t} {σ}_{yt}^{2} ) - ( \frac{1}{\sqrt{r}} {\sum }_{t = 1}^{r} {σ}_{yt}^{2} ) \qquad ( 9 )$$

It is to be understood that the degree of matching given by equation (9) is discussed merely for the purpose of illustration, without suggesting any limitation as to the scope of the invention. The degree of matching can be computed based on the variances of the target pixel in any suitable alternative ways.

The method 100 proceeds to step 130 where the pixel as a motion-blurred pixel or a non-motion-blurred pixel based on the degree of matching determined in step 120. In general, the pixel may be classified by comparing its matching degree with the blur kernels with a predefined threshold. If the degree of matching exceeds the threshold, the pixel is classified as a motion-blurred “foreground.” If the degree of matching is below the threshold, the pixel is classified as a non-motion-blurred “background.”

Particularly, in the above embodiments where the degree of matching is calculated according to equation (9), the threshold may be set as zero. That is, if P(n) exceeds zero, the pixel is classified as a motion-blurred pixel; otherwise, it is a non-motion-blurred pixel. Formally, the inventors have proved that if an image pixel I(i,j) is blurred by a blur kernel k, P(i,j) is not less than zero:

$$P ( i , j ) = ( {\sum }_{t = 1}^{r} {w}_{t} {σ}_{yt}^{2} ) - ( \frac{1}{\sqrt{r}} {\sum }_{t = 1}^{r} {σ}_{yt}^{2} ) \geq 0 \qquad ( 10 )$$

Otherwise, for a non-motion-blurred pixel, P(i,j) is less than zero:

$$P ( i , j ) = ( {\sum }_{t = 1}^{r} {w}_{t} {σ}_{yt}^{2} ) - ( \frac{1}{\sqrt{r}} {\sum }_{t = 1}^{r} {σ}_{yt}^{2} ) < 0 \qquad ( 11 )$$

In both inequations (10) and (11), it is assumed that x[n] represents the gradients of un-blurred version of I(i,j) in the small region centered at the position (i,j) , and yₜ[n] represents one of the feature maps by convolving x[n] with the corresponding local orthogonal filter fₜ. That is, yᵢ[n]=x[n] [symbol] (kₙ [symbol] fₜ) if the image pixel I(i,j) is blurred with the blur kernel kₙ which is spatial invariant in the small local region centered at the pixel. On the other hand, yₜ[n]=x[n] [symbol] fₜ if the image pixel I(i,j) is un-blurred, in which case the blur kernel can be regarded as a Dirac function. As discussed above, in some embodiments, the filter fₜ may be defined according to equation (1). In one embodiment, the window function W[n] may have the same supporting region as the local region centered at the pixel I(i,j).

It has been proved that σ_{yt}²=σₓ²σₖₜ². In this regard, reference can be made to “Analyzing Spatially-varying Blur,” Ayan Chakrabarti, Todd Zickler, and William T. Freeman, in Proceedings of the IEEE International Conference on Computer Vision and Pattern Recognition, 2010. As a result, a blur-indication function may be defined as follows:

$$\begin{matrix}h ( n ; {k}_{n} ) = ( {\sum }_{t = 1}^{r} \frac{{σ}_{kt}^{2}}{Δ} {σ}_{yt}^{2} ) - ( \frac{1}{\sqrt{r}} {\sum }_{t = 1}^{r} {σ}_{yt}^{2} ) \\ = ( {\sum }_{t = 1}^{r} \frac{{σ}_{kt}^{4} {σ}_{x}^{2}}{Δ} ) - ( \frac{1}{\sqrt{r}} {\sum }_{t = 1}^{r} {σ}_{x}^{2} {σ}_{kt}^{2} ) \\ = {\sum }_{t = 1}^{r} \frac{{ab}_{k}^{2}}{\sqrt{{\sum }_{t = 1}^{r} {b}_{t}^{2}}} - \frac{1}{\sqrt{r}} {\sum }_{t = 1}^{r} a \times {b}_{t} \\ ∝ \frac{{\sum }_{t = 1}^{r} {b}_{t}^{2}}{\sqrt{{\sum }_{t = 1}^{r} {b}_{t}^{2}}} - \frac{1}{\sqrt{r}} {\sum }_{t = 1}^{r} {b}_{t} \\ = \sqrt{{\sum }_{t = 1}^{r} {b}_{t}^{2}} - \frac{1}{\sqrt{r}} {\sum }_{t = 1}^{r} {b}_{t} .\end{matrix} \qquad ( 12 )$$

where a [symbol] σₓ² and bₜ [symbol] σₖₜ². Therefore, inequation (10) can be proved if the following inequation is proved:

$$\sqrt{{\sum }_{t = 1}^{r} {b}_{t}^{2}} \geq \frac{1}{\sqrt{r}} {\sum }_{t = 1}^{r} {b}_{t} \qquad ( 13 )$$

Because both sides of (13) are non-negative, it is equivalent to prove the following inequation:

$${\sum }_{t = 1}^{r} {b}_{t}^{2} \geq \frac{1}{r} {( {\sum }_{t = 1}^{r} {b}_{t} )}^{2} \qquad ( 14 )$$

### That is

$${( {\sum }_{t = 1}^{r} {b}_{t} )}^{2} \leq r {\sum }_{t = 1}^{r} {b}_{t}^{2} \qquad ( 15 )$$

Inequation (15) can be proved by applying the Cauchy-Schwarz Inequality. As known, according to the Cauchy-Schwarz Inequality, for all vectors x and y of an inner product space, it is true that

∥ [symbol] x,y [symbol] ∥₂²≦ [symbol] x,x [symbol] × [symbol] y,y [symbol] (16)

### Let

x [symbol] (b₁,b₁, . . . ,bᵣ) (17)

and

y [symbol] (1,1, . . . ,1)ε [symbol] ^{r} (18)

Substituting (17) and (18) into (16) can yield (15), thereby proving inequation (10).

Inequation (11) can be proved in a similar way. More specifically, because σₖₜ²=1 when there is no blur, σ_{yt}²=σₓ²σₖₜ²=σₓ². Accordingly, the blur-indicator function becomes:

$$\begin{matrix}h ( n ; {k}_{n} ) = ( {\sum }_{t = 1}^{r} \frac{{σ}_{kt}^{2}}{Δ} {σ}_{yt}^{2} ) - ( \frac{1}{\sqrt{r}} {\sum }_{t = 1}^{r} {σ}_{yt}^{2} ) \\ = ( {\sum }_{t = 1}^{r} \frac{{σ}_{kt}^{4} {σ}_{x}^{2}}{Δ} ) - ( \frac{1}{\sqrt{r}} {\sum }_{t = 1}^{r} {σ}_{x}^{2} ) \\ ∝ {\sum }_{t = 1}^{r} \frac{{b}_{t}}{\sqrt{{\sum }_{i = 1}^{r} {b}_{i}^{2}}} - \frac{r}{\sqrt{r}} .\end{matrix} \qquad ( 19 )$$

The problem is equivalent to prove

$${( {\sum }_{t = 1}^{r} \frac{{b}_{t}}{{\sum }_{i = 1}^{r} {b}_{i}^{2}} )}^{2} - {( \frac{r}{\sqrt{r}} )}^{2} < 0 \qquad ( 20 )$$

which is equivalent to

$${( {\sum }_{t = 1}^{r} {b}_{t} )}^{2} \leq r {\sum }_{t = 1}^{r} {b}_{t}^{2} \qquad ( 21 )$$

Inequation (21) is identical to inequation (15) which has been proved by using the Cauchy-Schwarz Inequality. This completes the proof of inequation (11).

With the method 100, it is possible to determine whether the given pixel in the image is a motion-blurred foreground pixel or a non-motion-blurred background pixel. By applying this method to each pixel in the image, the moving object can be detected.

For example, the regions containing a predefined number or ratio of the foreground pixels may be recognized as a moving object.

Specifically, in some embodiments, the moving objects may be detected from a video clip. FIG. 2 shows the flowchart of such a method of moving object detection in a video clip in accordance with embodiments of the present invention.

The method 200 is entered at step 210, where a pixel in a frame from among a plurality of frames [x_{t-T},x_{t-T-1}, . . . , xₜ₋₂xₜ₋₁,xₜ] in the video is classified as a motion-blurred pixel or a non-motion-blurred pixel. In step 210, the pixel is classified by applying the method 100 as discussed above.

Then the method 200 proceeds to step 220 to determine whether there are more pixels to be classified in the current frame. If so, the method 200 returns to step 210 to classify a next pixel in the current frame. Otherwise, if it is determined in step 220 that all the pixels in the current frame have been classified, the method 200 proceeds to step 230 to generate a foreground indicator for the frame.

In some embodiments, the frame-level foreground indicator may be implemented as a foreground-indicator vector which indicates the motion-blurred pixels. For example, the elements in the foreground-indicator vector that correspond to motion-blurred pixels may be set as “1” while the elements that correspond to non-motion-blurred pixels may be set as “0.”

Then, in step 240, it is determined whether there are more frames in the video to be processed. If so, steps 210 to 230 are repeated to process a further frame. On the other hand, if all the frames have been processed, the method 200 proceeds to step 250. In step 250, a foreground indicator for the video is generated based on the foreground indicators for the plurality of frames. In some embodiment, this video-level foreground indicator may be implemented as a foreground-indicator vector which can be formed by combing the foreground-indicator vectors for the frames.

Generally speaking, in accordance with embodiments of the present invention, the i-th element sᵢ of foreground-indicator vector s equals to either zero or one, as follows:

$${s}_{i} = \{ \begin{matrix}1 & if pixel i is foreground \\ 0 & if pixel i is background\end{matrix} \qquad ( 22 )$$

In order to construct the video-level foreground-indicator vector s, the frame-level foreground-indicator vectors may be combined in various ways. For example, in one embodiment, the element s(i) of the video-level foreground-indicator vector is set 1 if the elements for the pixel i are 1's in a predefined number of frame-level foreground-indicator vectors (that is, in these frames, the pixel i is determined to be motion-blurred.) It is to be understood that, this approaches is given merely for the purpose of illustration without suggesting any limitation as to the scope of the invention. Any other suitable algorithms for combing the frame-level foreground-indicator vectors can be used as well.

Next the method 200 proceeds to step 260, where the moving object(s) may be detected from the video based on the foreground indicator for the video as generated in step 250. More specifically, the pixel value of the foreground can be determined according to the foreground indicator for the video:

$${p}_{s} ( {x}_{t} ) = \{ \begin{matrix}0 , & if & {s}_{i} = 0 \\ {x}_{t} ( i ) & if & {s}_{i} = 1\end{matrix} \qquad ( 23 )$$

where pₛ represents the foreground-extract operator. The pixel value of the background can also be determined according to the foreground-indicator vector:

$${\overline{p}}_{s} ( {x}_{t} ) = \{ \begin{matrix}{x}_{t} ( i ) , & if & {s}_{i} = 0 \\ 0 & if & {s}_{i} = 1\end{matrix} \qquad ( 24 )$$

where pₛ represents the background-extract operator.

Contrary to the conventional solutions that considers the difference between neighboring images as moving objects, embodiments of the present invention utilizes such blur clue for detection moving objects. In this way, it is possible to avoid the negative impact of the factors that may cause inter-frame difference such as illumination changes, dynamic background, and noise. Based on the motion blur information which directly and completely corresponds to moving objects, embodiments of the present invention is more robust, achieving less false alarms and high detection rate.

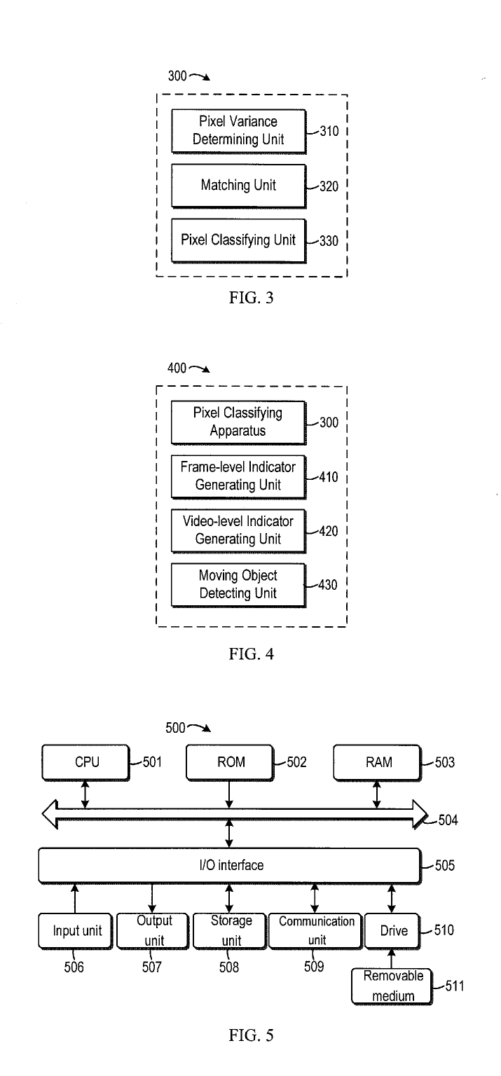

FIG. 3 shows a block diagram of an apparatus in accordance with example embodiments of the present invention. As shown, the apparatus 300 comprises a pixel variance determining unit 310 configured to determine variances of a pixel in an image for a set of frequencies based on a gradient of the pixel; a matching unit 320 configured to calculate a degree of matching between the pixel and a set of blur kernels for the set of frequencies based on the variances of the pixel, each of the blur kernels characterizing a type of motion that causes a blur in the image; and a pixel classifying unit 330 configured to classify the pixel as a motion-blurred pixel or a non-motion-blurred pixel based on the degree of matching.

In some embodiments, the pixel variance determining unit 310 comprises a gradient image generating unit configured to generate a gradient image of the image; a region extracting unit configured to extract a region around the pixel from the gradient image; and a region filtering unit configured to filter the region with a set of filters corresponding to the set of frequencies to obtain the variances of the pixel.

In some embodiments, the matching unit 320 comprises a kernel variance determining unit configured to determine variances of the blur kernels for the set of frequencies. In those embodiments, the degree of matching is calculated based on the variances of the pixel and the variances of the blur kernels. For example, the degree of matching may be calculated according to equation (9).

In some embodiments, the pixel classifying unit 330 is configured to classify the pixel as a motion-blurred pixel if the degree of matching exceeds a predefined value; and classify the pixel as a non-motion-blurred pixel if the degree of matching is below the predefined value.

FIG. 4 shows a block diagram of an apparatus in accordance with example embodiments of the present invention. As shown, the apparatus 400 comprises the pixel classifying apparatus 300 as discussed above with reference to FIG. 3. The apparatus 300 is configured to classify each pixel in each of a plurality of frames in a video as a motion-blurred pixel or a non-motion-blurred pixel. The apparatus 400 further comprises a frame-level indicator generating unit 410 configured to generate foreground indicators for the plurality of frames based on the classifying, each of the foreground indicators indicating the motion-blurred pixels in the respective frame; a video-level indicator generating unit 420 configured to generate a foreground indicator for the video based on the foreground indicators for the plurality of frames; and a moving object detecting unit 430 configured to detect a moving object in the video based on the foreground indicator for the video.

FIG. 5 shows a block diagram of an example computer system 500 suitable for implementing example embodiments of the present invention. The computer system 500 can be a fixed type machine such as a desktop personal computer (PC), a server, a mainframe, or the like. Alternatively, the computer system 500 can be a mobile type machine such as a mobile phone, tablet PC, laptop, intelligent phone, personal digital assistance (PDA), or the like.

As shown, the computer system 500 comprises a processor such as a central processing unit (CPU) 501 which is capable of performing various processes in accordance with a program stored in a read only memory (ROM) 502 or a program loaded from a storage unit 508 to a random access memory (RAM) 503. In the RAM 503, data required when the CPU 501 performs the various processes or the like is also stored as required. The CPU 501, the ROM 502 and the RAM 503 are connected to one another via a bus 504. An input/output (I/O) interface 505 is also connected to the bus 504.

The following components are connected to the I/O interface 505: an input unit 506 including a keyboard, a mouse, or the like; an output unit 507 including a display such as a cathode ray tube (CRT), a liquid crystal display (LCD), or the like, and a loudspeaker or the like; the storage unit 508 including a hard disk or the like; and a communication unit 509 including a network interface card such as a LAN card, a modem, or the like. The communication unit 509 performs a communication process via the network such as the Internet. A drive 510 is also connected to the I/O interface 505 as required. A removable medium 511, such as a magnetic disk, an optical disk, a magneto-optical disk, a semiconductor memory, or the like, is mounted on the drive 510 as required, so that a computer program read therefrom is installed into the storage unit 508 as required.

Specifically, in accordance with example embodiments of the present invention, the processes described above with reference to FIGS. 1 and 2 may be implemented by computer program. For example, embodiments of the present invention comprise a computer program product including a computer program tangibly embodied on a machine readable medium, the computer program including program code for performing the method 100 and/or method 200. In such embodiments, the computer program may be downloaded and mounted from the network via the communication unit 509, and/or installed from the removable medium 511.

The functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Various embodiments of the invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present invention can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various implementations. Machine-executable instructions for program modules may be executed within a local or distributed device. In a distributed device, program modules may be located in both local and remote storage media.

Program code for carrying out methods of the invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the the present invention, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination

Although the invention has been described in language specific to structural features and/or methodological acts, it is to be understood that the invention defined in the appended claims is not necessarily limited to the specific features or acts described above. Rather, the specific features and acts described above are disclosed as example forms of implementing the claims.

1-16. (canceled)

17. A method comprising:
determining variances of a pixel in an image for a set of frequencies based on a gradient of the pixel;
calculating a degree of matching between the pixel and a set of blur kernels for the set of frequencies based on the variances of the pixel, each of the blur kernels characterizing a type of motion that causes a blur in the image; and
classifying the pixel as a motion-blurred pixel or a non-motion-blurred pixel based on the degree of matching.

18. The method of claim 17, wherein determining the variances of the pixel for the set of frequencies comprises:
generating a gradient image of the image;
extracting a region around the pixel from the gradient image; and
determining the variances of the pixel by filtering the region with a set of filters corresponding to the set of frequencies.

19. The method of claim 17, wherein calculating the degree of matching between the pixel and the set of blur kernels comprises:
determining variances of the blur kernels for the set of frequencies; and
calculating the degree of matching based on the variances of the pixel and the variances of the blur kernels.

20. The method of claim 19, wherein calculating the degree of matching based on the variances of the pixel and the variances of the blur kernels comprises:
normalizing the variances of the blur kernels for the set of frequencies; and
calculating the degree of matching as
$$P = ( {\sum }_{t = 1}^{r} {w}_{t} {σ}_{yt}^{2} ) - ( \frac{1}{\sqrt{r}} {\sum }_{t = 1}^{r} {σ}_{yt}^{2} ) ,$$
wherein r represents the number of the frequencies, wₜ represents the normalized variances of the blur kernels for the set of frequencies, and σ_{yt}², represents the variance of the pixel for the t-th frequency in the set of frequencies.

21. The method of claim 20, wherein normalizing the variances of the blur kernels for the set of frequencies comprises:
generating the normalized variances of the blur kernels for the set of frequencies as
$${w}_{t} = \frac{{σ}_{kt}^{2}}{Δ} ,$$
wherein σₖₜ² represents the variance of the blur kernels for the t-th frequency in the set of frequencies.

22. The method of claim 17, wherein classifying the pixel comprises:
classifying the pixel as a motion-blurred pixel if the degree of matching exceeds a predefined value; and
classifying the pixel as a non-motion-blurred pixel if the degree of matching is below the predefined value.

23. An apparatus comprising:
at least one processor; and
at least one memory including computer program code, the at least one processor, the at least one memory, and the computer program code configured to cause the apparatus to at least:
determine variances of a pixel in an image for a set of frequencies based on a gradient of the pixel;
calculate a degree of matching between the pixel and a set of blur kernels for the set of frequencies based on the variances of the pixel, wherein each of the blur kernels characterizes a type of motion that causes a blur in the image; and
classify the pixel as a motion-blurred pixel or a non-motion-blurred pixel based on the degree of matching.

24. The apparatus of claim 23, wherein the apparatus is further configured to at least:
generate a gradient image of the image;
extract a region around the pixel from the gradient image; and
filter the region with a set of filters corresponding to the set of frequencies to determine the variances of the pixel.

25. The apparatus of claim 23, wherein the apparatus is further configured to at least:
determine variances of the blur kernels for the set of frequencies,
wherein the degree of matching is calculated based on the variances of the pixel and the variances of the blur kernels.

26. The apparatus of claim 25, wherein the degree of matching is calculated as
$$P = ( {\sum }_{t = 1}^{r} {w}_{t} {σ}_{yt}^{2} ) - ( \frac{1}{\sqrt{r}} {\sum }_{t = 1}^{r} {σ}_{yt}^{2} ) ,$$
wherein r represents the number of the frequencies, wₜ represents normalized variances of the blur kernels for the set of frequencies obtained by normalizing the variances of the blur kernels for the set of frequencies, and σ_{yt}² represents the variance of the pixel for the t-th frequency in the set of frequencies.

27. The apparatus of claim 26, wherein the normalized variances of the blur kernels are generated as
$${w}_{t} = \frac{{σ}_{kt}^{2}}{Δ} ,$$
wherein σₖₜ² represents the variance of the blur kernels for the t-th frequency in the set of frequencies.

28. The apparatus of claim 23, where in the apparatus is further configured to at least:
classify the pixel as a motion-blurred pixel if the degree of matching exceeds a predefined value; and
classify the pixel as a non-motion-blurred pixel if the degree of matching is below the predefined value.
